(19) United States
(12) Patent Application Publication
(10) Pub. No.: US 2024/0326270 A1
(43) Pub. Date: Oct. 3, 2024

(54) ELECTRIC HAIR GROOMING APPLIANCE INCLUDING PIVOT ASSEMBLY

(71) Applicant: Spectrum Brands, Inc., Middleton, WI (US)

(72) Inventors: Benjamin Miles Cleppe, Verona, WI (US); Michael John deGrood, Middleton, WI (US); William Roberts, Blackburn (GB); Stephen A. Latham, Sun Prairie, WI (US); Eric William Henry Gobrecht, Madison, WI (US); Kenichi Karasawa, Yamagata (JP); Andrew Davis Edge, Brookline, MA (US)

(21) Appl. No.: 18/579,120

(22) PCT Filed: Jul. 8, 2022
(86) PCT No.: PCT/US2022/036466

§ 371 Date: Jan. 12, 2024

Related U.S. Application Data
(60) Provisional application No. 63/220,832, filed on Jul. 12, 2021.

(51) Int. Cl. B26B 19/14

(52) U.S. Cl. CPC B26B 19/146

(57) ABSTRACT

An electric hair grooming appliance includes a handle and a hair grooming device. The electric hair grooming appliance also includes a pivot assembly pivotably attaching the hair grooming device to the handle. The pivot assembly includes a spherical housing. The hair grooming device and the spherical housing are pivotable relative to the handle about at least two pivot axes extending through the spherical housing. The electric hair grooming appliance further includes a motor contained in the spherical housing. The motor is configured to drive the hair grooming device.

### CROSS-REFERENCE TO RELATED APPLICATIONS

This application claims priority to U.S. Provisional Patent Application No. 63/220,832, filed on Jul. 12, 2021 and titled “ELECTRIC HAIR GROOMING APPLIANCE INCLUDING PIVOT ASSEMBLY”, the disclosure of which is hereby incorporated by reference in its entirety.

### FIELD OF THE DISCLOSURE

The present disclosure relates generally to an electric hair grooming appliance, and more specifically, to an electric hair grooming appliance including a pivot assembly.

### BACKGROUND OF THE DISCLOSURE

Conventional hair grooming appliances include a head that supports one or more hair grooming devices, such as cutting assemblies, that are used to groom hair. During a grooming operation, the hair grooming devices are moved along skin to groom hair protruding from the skin. Typically, it is desirable to keep the head assembly in contact with or at least in close proximity to the skin during operation to provide an even and consistent grooming operation. However, the skin may have contours that are difficult to follow with the grooming device. Accordingly, some hair grooming appliances include a pivot assembly that allows a head to pivot relative to a handle when the head encounters contours of the skin. However, some pivot assemblies may not provide the head with sufficient freedom of movement to follow the skin. For example, the pivot assemblies may only allow the head to pivot in a single direction. In addition, some pivot assemblies include complex suspension members or moving frames that can be difficult to assemble and maintain. Also, some users desire a specific appearance and/or feel of the hair grooming appliance and the visual appearance of some pivoting heads may not be satisfactory for some users.

Typical hair grooming appliances include a drive system that is positioned within the handle and extends into the head to drive the hair grooming device. For example, the drive system may include a motor and a drive shaft that couples to a transmission system within the head. In addition, some drive systems extend across a pivot interface and the drive system must accommodate the pivoting motion of the head relative to the handle. As a result, the drive systems of hair grooming appliances are complex and can be difficult to assemble and maintain.

Accordingly, there is a need for a hair grooming appliance with a pivot assembly that is simple to assemble, operate, and maintain and that allows for a head of the hair grooming appliance to comfortably follow the contours of skin during a grooming operation.

### SUMMARY

In one aspect, an electric hair grooming appliance includes a handle and a hair grooming device. The electric hair grooming appliance also includes a pivot assembly pivotably attaching the hair grooming device to the handle. The pivot assembly includes a spherical housing. The hair grooming device and the spherical housing are pivotable relative to the handle about at least two pivot axes extending through the spherical housing. The electric hair grooming appliance further includes a motor contained in the spherical housing. The motor is configured to drive the hair grooming device.

In another aspect, an electric hair grooming appliance includes a handle and a hair grooming device. The electric hair grooming appliance also includes a pivot assembly pivotably attaching the hair grooming device to the handle and including a spherical housing. The hair grooming device and the spherical housing are pivotable relative to the handle about at least two pivot axes extending through the spherical housing. The electric hair grooming appliance further includes a bias member disposed between the pivot assembly and the handle. The bias member includes an outer edge configured to engage the handle and an inner edge configured to engage the pivot assembly. The bias member is configured to bias the spherical housing against movement about the at least two pivot axes.

In another aspect, an electric hair grooming appliance includes a handle, a hair grooming device, and a pivot assembly pivotably attaching the hair grooming device to the handle. The pivot assembly includes a spherical housing and a strap. The spherical housing has a circumference. The strap extends at least partly around the circumference of the spherical housing and pivotably supports the spherical housing. The hair grooming device and the spherical housing are pivotable relative to the handle about at least two pivot axes extending through the spherical housing.

### BRIEF DESCRIPTION OF THE DRAWINGS

FIG. 1 is a perspective view of one suitable embodiment of an electric hair grooming appliance of the present disclosure, the electric hair grooming appliance including a handle, a grooming device, and a pivot assembly pivotally connecting the grooming device to the handle:

FIG. 2 is another perspective view of the electric hair grooming appliance showing the back of the appliance, the pivot assembly including a spherical housing:

FIG. 3 is a front view of the electric hair grooming appliance:

FIG. 4 is a back view of the electric hair grooming appliance illustrating the spherical housing of the pivot assembly:

FIG. 5 is a side view of the electric hair grooming appliance:

FIG. 6 is a top view of the electric hair grooming appliance:

FIG. 7 is a bottom view of the electric hair grooming appliance:

FIG. 8 is a sectional view of the electric hair grooming appliance taken along line A-A shown in FIG. 3, the electric hair grooming appliance including a motor disposed within the spherical housing of the pivot assembly and a power supply operatively connected to the motor and disposed with the handle:

FIG. 9 is an enlarged view of a portion of the sectional view of the electric hair grooming appliance shown in FIG. 8:

FIG. 10 is a perspective view of the electric hair grooming appliance with the grooming device detached from the pivot assembly:

FIG. 11 is a perspective view of the pivot assembly and the handle, the grooming device being removed from the pivot assembly and not shown;

FIG. 12 is a back view of the grooming device;

FIG. 13 is a perspective view of a portion of the electric hair grooming appliance showing the grooming device attached to the pivot assembly, the outer housing of the handle being removed to show internal components of the pivot assembly;

FIG. 14 is a perspective view of the pivot assembly;

FIG. 15 is a partial sectional view of the electric hair grooming appliance taken along line B-B shown in FIG. 5;

FIG. 16 is another perspective view of the pivot assembly;

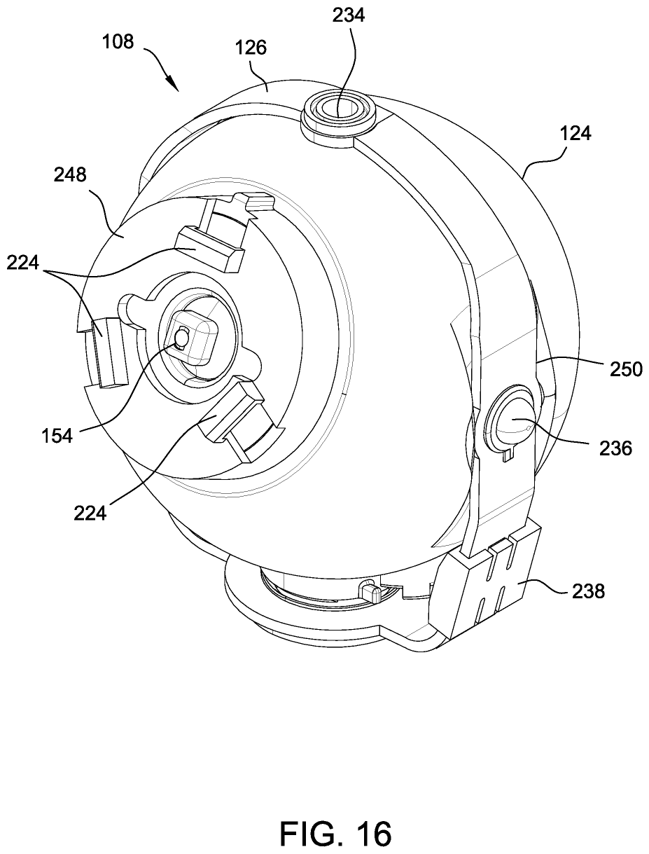

FIG. 17 is a top view of the pivot assembly;

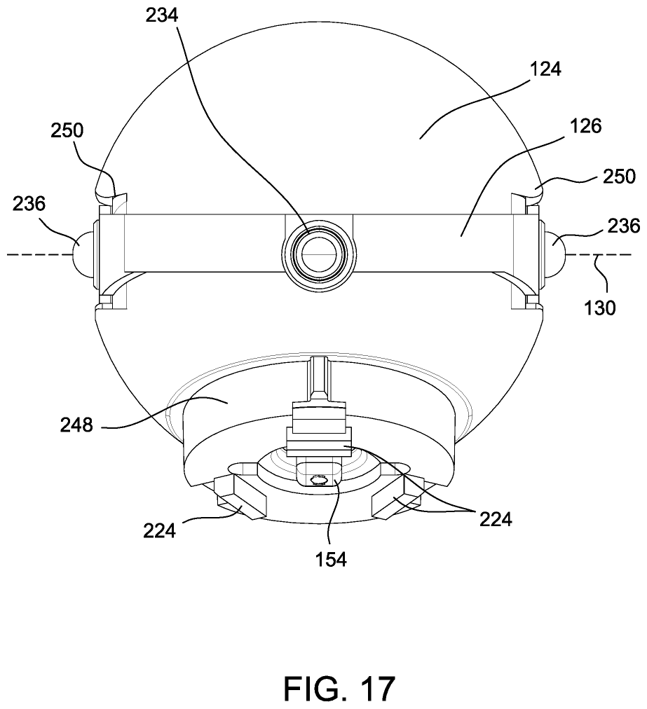

FIG. 18 is a front view of the pivot assembly;

FIG. 19 is a side view of the pivot assembly;

FIG. 20 is a perspective view of the spherical housing of the pivot assembly with components removed to show underlying structure;

FIG. 21 is a front view of the spherical housing shown in FIG. 20;

FIG. 22 is a bottom view of the spherical housing shown in FIG. 20;

FIG. 23 is a perspective view of a strap of the pivot assembly;

FIG. 24 is a front view of the strap;

FIG. 25 is a perspective view of the handle of the electric hair grooming appliance, the grooming device and the pivot assembly being removed;

FIG. 26 is an enlarged perspective view of a portion of the handle shown in FIG. 25, the handle including a bias member;

FIG. 27 is a back view of the handle:

FIG. 28 is a perspective view of the bias member of the handle:

FIG. 29 is a front view of the bias member;

FIG. 30 is a side view of the bias member:

FIG. 31 is a top view of the bias member:

FIG. 32 is a side view of a portion of the electric hair grooming appliance with the grooming device of the electric hair grooming appliance in an opened position:

FIG. 33 is a perspective view of another embodiment of the strap shown in FIG. 23 suitable for use with the electric hair grooming appliance shown in FIGS. 1-7, the strap configured to extend partially around the circumference of the spherical housing of the electric hair grooming appliance; and

FIG. 34 is a perspective view of a portion of an exemplary embodiment of an electric hair grooming appliance, the electric hair grooming appliance including another embodiment of the bias member shown in FIG. 28, the bias member including a helical spring.

### DETAILED DESCRIPTION OF THE DRAWINGS

The present disclosure contemplates multiple embodiments of an electric hair grooming appliance illustrated in the accompanying figures. The electric hair grooming device is configured for a user to perform a grooming operation such as cutting or otherwise removing hair from skin. For example, the electric hair grooming appliance includes a grooming device, a handle, and a pivot assembly that facilitates the grooming device pivoting relative to the handle. The pivot assembly includes a spherical housing and a strap that pivotably supports the spherical housing. The strap of the pivot assembly is mounted to a bearing on the handle that allows the pivot assembly to move relative to the handle. As a result, the pivot assembly facilitates the grooming device moving about at least two axes relative to the handle. The spherical housing and the strap provide a smooth, consistent movement of the pivot assembly and are configured to facilitate the grooming device following contours of skin during a grooming operation.

The electric hair grooming appliance includes a drive system with a motor that is positioned within the spherical housing. Because the motor is positioned within the spherical housing, the drive system of the electric hair grooming appliance does not extend across a pivot interface and the drive system pivots with the spherical housing and the grooming device relative to the handle. As a result, the electric hair grooming appliance of the present disclosure is simpler to manufacture and maintain compared to other appliances.

In some embodiments, the handle of the electric hair grooming appliance includes a bias member that biases the grooming device toward an operating position. The bias member includes a corrugated, elastic sheet that biases the grooming device in multiple directions and provides a consistent bias force to return the grooming device to the operating position if the grooming device is displaced.

Also, in some embodiments, the grooming device is selectively detachable from the pivot assembly. For example, the pivot assembly provides a snap fit connection that allows the grooming device to be manually detached from the handle by pulling and reattached to the handle by pushing the grooming device relative to the pivot assembly.

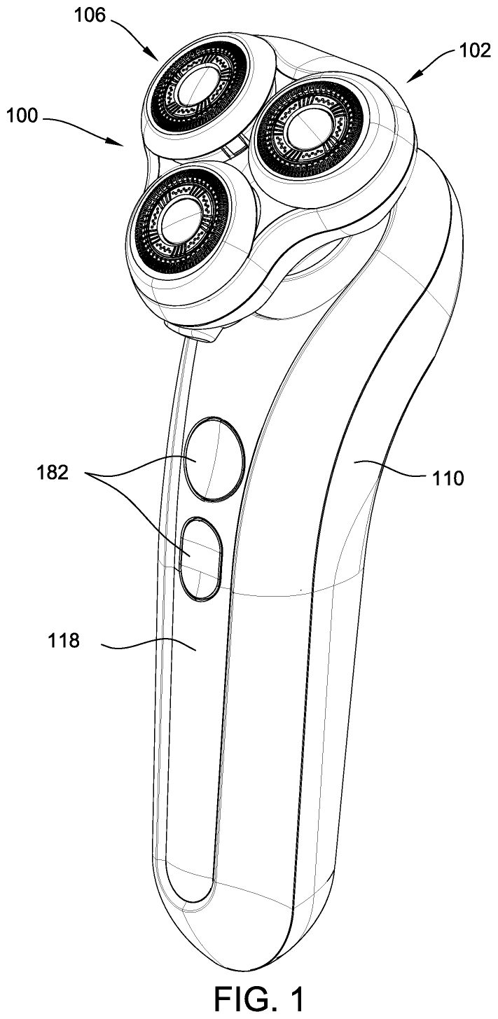

Referring now to FIG. 1, one suitable embodiment of an electric hair grooming appliance of the present disclosure is indicated generally at 100. The electric hair grooming appliance 100 includes a head 102 including a cutting assembly, broadly a grooming device, 106. In the illustrated embodiment, for example, the electric hair grooming appliance 100 is configured to cut hair. In other suitable embodiments, the grooming appliance 100 may be any suitable grooming appliance including, for example and without limitation, a shaver, an epilator, a hair trimming device, an intense pulsed light (IPL) device, a laser device, a skincare device, a brush, a massager, and/or any other suitable grooming device.

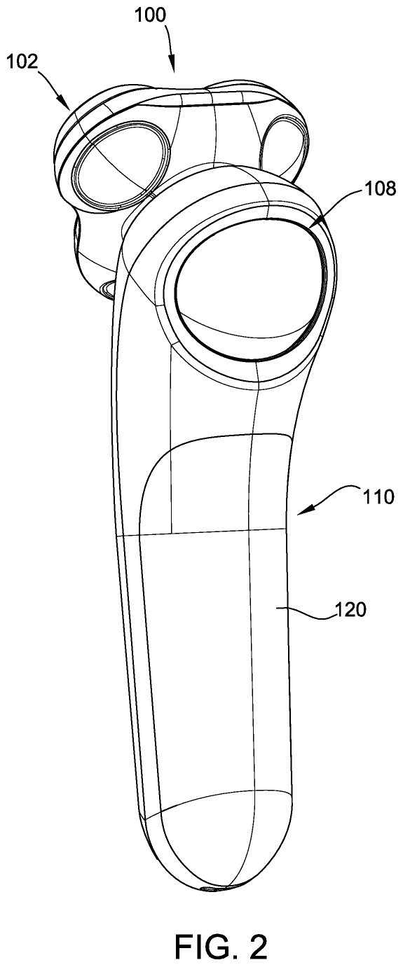

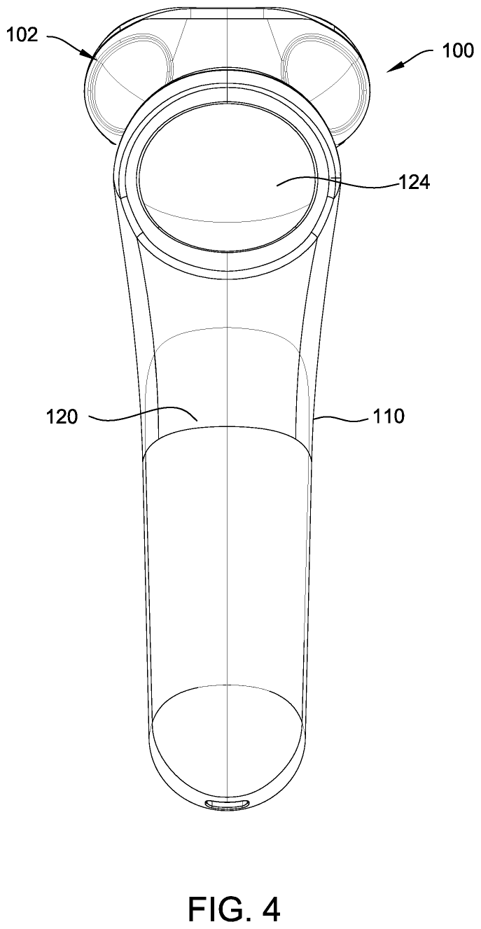

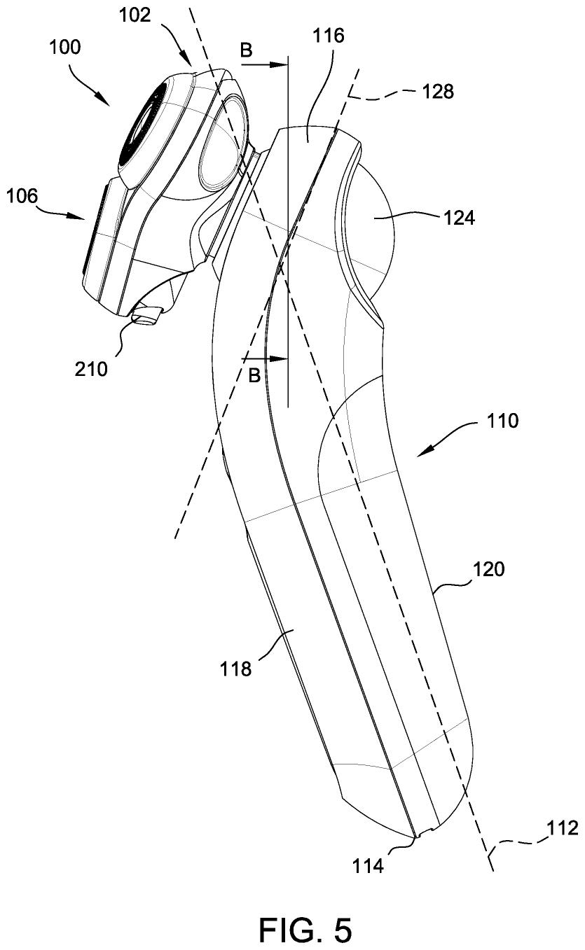

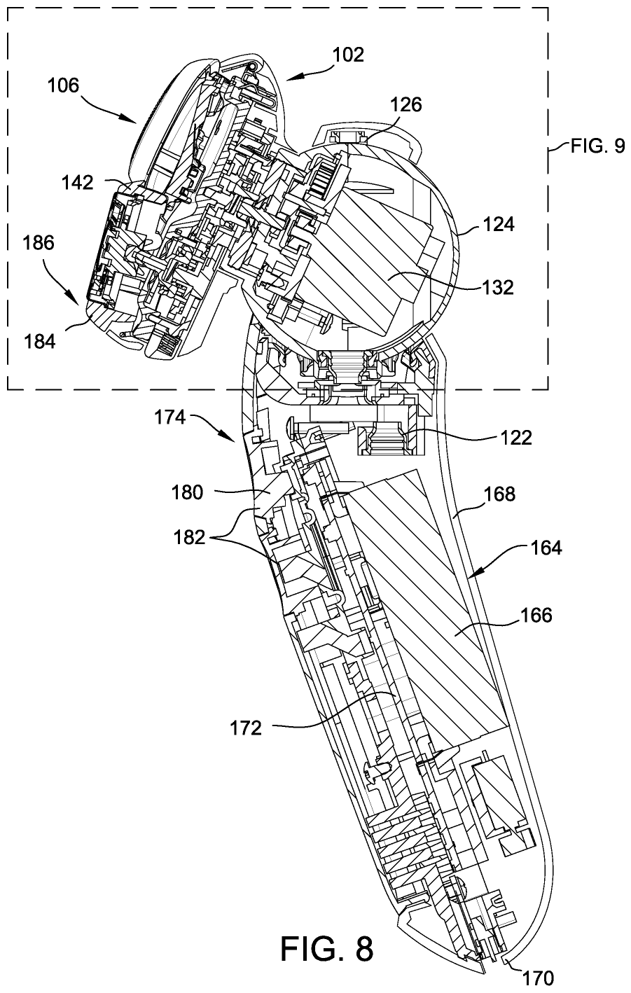

With reference to FIGS. 2-8, the electric hair grooming appliance 100 includes a pivot assembly 108 and a handle 110. The handle 110 has a first end 114 and a second end 116. As seen in FIG. 5, a handle axis 112 extends longitudinally through the handle 110 from a first end 114 to a second end 116. The handle 110 includes a handle front 118 and a handle back 120. The handle 110 includes a battery compartment 168 and defines a handle cavity 122 (shown in FIG. 8). The handle 110 is suitably sized and shaped such the handle 110 may be easily held in a user's hand during a grooming session. In other suitable embodiments, the handle 110 may have other components without departing from some aspects of the disclosure.

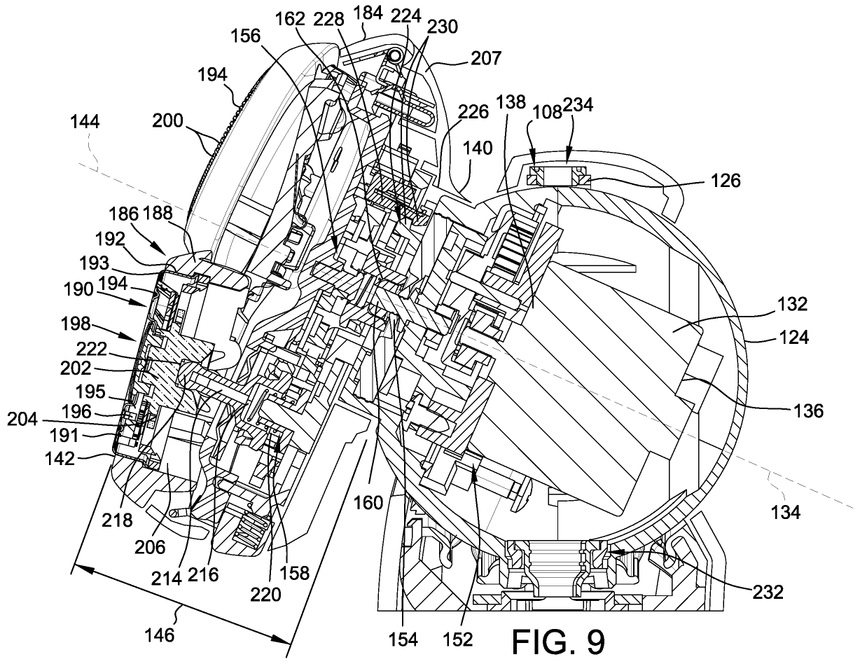

As seen in FIGS. 8 and 9, the pivot assembly 108 pivotably supports the head 102 on the handle 110. The pivot assembly 108 includes a spherical housing 124 and a strap 126. As described in further detail herein, the head 102 and the spherical housing 124 are pivotable relative to the handle 110 about at least two pivot axes 128, 130 extending through the spherical housing 124. The handle 110 and the pivot assembly 108 are arranged to provide an appearance of a ball and socket joint that is aesthetically pleasing for a user. In addition, the pivot assembly 108 includes less parts and is simpler to assemble and maintain than pivot assemblies that include complicated suspension assemblies.

As shown in FIG. 9, the electric hair grooming appliance 100 includes a motor 132 mounted within the spherical housing 124 of the pivot assembly 108. The motor 132 may be any shape. For example, in some embodiments, the motor 132 may be cylindrical, spherical, cuboid, prismatic, conical, or any other suitable shape. In the illustrated embodiment, the motor 132 is cylindrical in shape. The motor 132 includes a first end 136 and a second end 138. The motor 132 has a motor axis 134 extending from the first end 136 to the second end 138 and passing through the center of the motor 132.

Referring to FIGS. 5-9, the head 102 includes a back 140 and a front 142. The back 140 is detachably connected to the pivot assembly 108. The head 102 extends along a head axis 144 extending from the back 140 to the front 142. The head axis 144 is oblique to the handle axis 112 and coaxial with the motor axis 134. The head 102 has a length 146 defined from the back 140 to the front 142. The back 140 is circular and has a diameter 148. The front 142 of the head 102 is a reuleaux triangle with three sides and has a width 150. The width 150 of the front 142 is greater than the diameter 148 of the back 140.

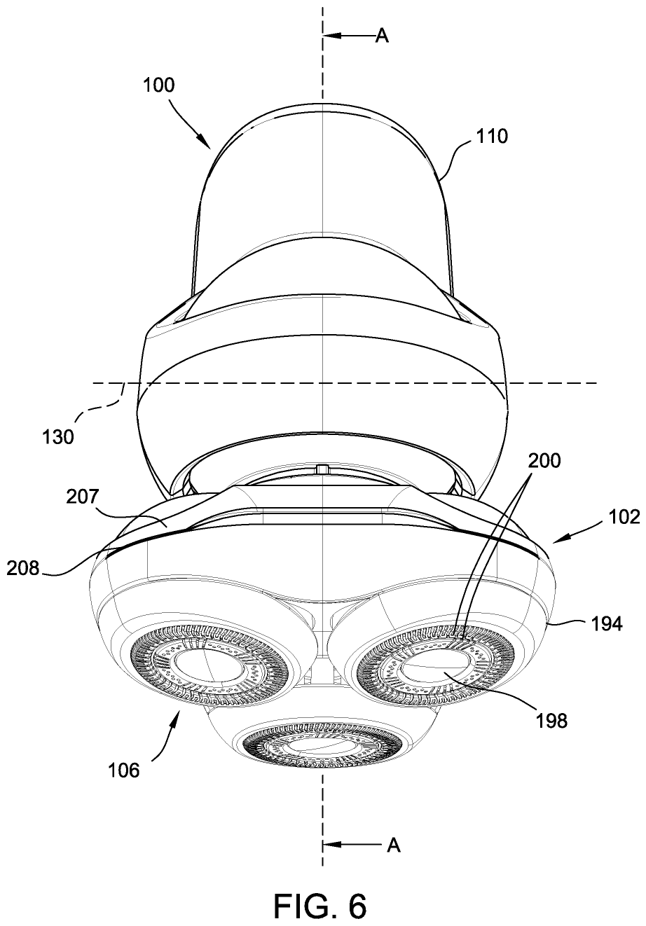

The head 102 is configured to pivot via the pivot assembly 108 about at least two axes 128, 130 (shown in FIGS. 5 and 6) relative to the handle 110. For example, the head 102 is configured to pivot about the first pivot axis 128 and the second pivot axis 130. The first pivot axis 128 and the second pivot axis 130 extend through the spherical housing 124 and the motor 132. In addition, the first pivot axis 128 and the second pivot axis 130 are not parallel to the handle axis 112. During a grooming operation, the head 102 is configured to move about the pivot axes 128, 130 to follow the contours of the skin. The head 102 is better able to follow contours of the skin because the pivot assembly 108 facilitates the head 102 having freedom of movement in multiple directions. Moreover, the weight of the electric hair grooming appliance 100 is more balanced during operation and the electric hair grooming appliance 100 is easier for a user to handle because the pivot axes 128, 130 extend through the spherical housing 124 and the motor 132.

Referring to FIGS. 8 and 9, the electric hair grooming appliance 100 includes a drive assembly 152. The drive assembly 152 is contained within the head 102 and the spherical housing 124. The drive assembly 152 includes the motor 132, a motor drive shaft 154, a coupling unit 156, and a drive train 158. As mentioned above, the motor 132 in the illustrated embodiment is contained within the spherical housing 124 of the pivot assembly 108. The motor drive shaft 154 is operatively connected to the motor 132. When activated, the motor 132 causes the motor drive shaft 154 to rotate at one or more predetermined speeds. The motor drive shaft 154 may be connected to the motor 132 in any manner that enables the electric hair grooming appliance 100 to function as described herein such as, for example and without limitation, gears, linkages, adhesives, belt drives and/or welding. In the illustrated embodiment, the motor drive shaft 154 extends outward from the motor 132 along the motor axis 134 and motor drive shaft into the head 102. The motor drive shaft 154 is positioned to rotate about the motor axis 134. The electric hair grooming appliance 100 may include different drive assemblies without departing from some aspects of this disclosure.

The motor drive shaft 154 includes a key 160 that is configured to engage the coupling unit 156 when the head 102 is attached to the pivot assembly 108 and the handle 110. The coupling unit 156 is at least partially contained within the head 102 and configured to receive the key 160. For example, the coupling unit 156 defines a keyed slot 162 sized and shaped to receive the key 160. The key 160 is configured to mate with the keyed slot 162 such that the key 160 and the keyed slot 162 couple the motor drive shaft 154 and the coupling unit 156 together. Rotation of the motor drive shaft 154 by the motor 132 in turn causes rotation of the coupling unit 156 when the key 160 is engaged with the coupling unit 156. In other suitable embodiments, the drive assembly 152 may include any additional mechanisms which enable the electric hair grooming appliance 100 to function as described herein.

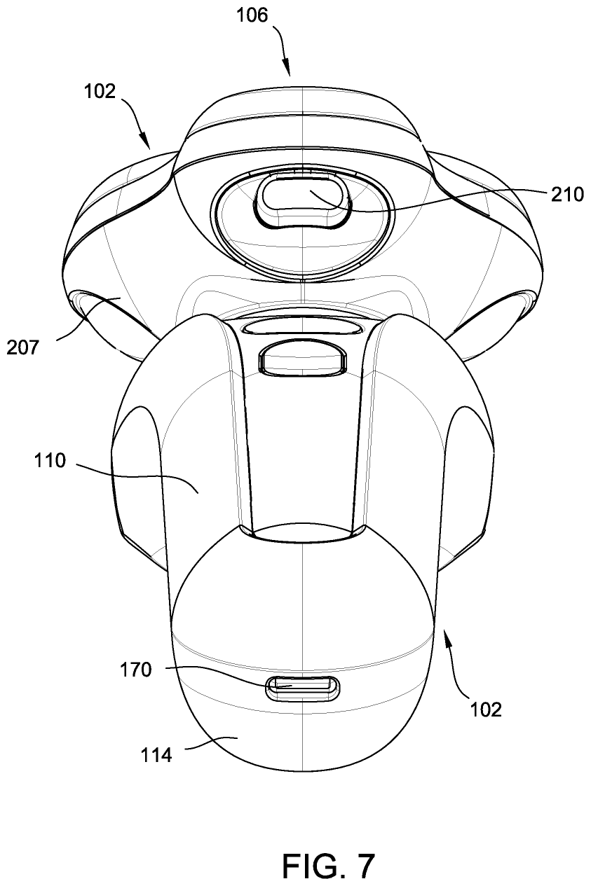

With reference to FIG. 8, the grooming appliance 100 receives power from either an external power supply or internal power supply 164. For example, the power supply 164 of the illustrated embodiment is a battery 166 positioned within the battery compartment 168. The handle 110 of the electric hair grooming appliance 100 includes a port 170 (shown in FIG. 7) extending from the battery compartment 168 to an exterior of the handle 110 at the first end 114. The port 170 is adapted to receive a cable to connect the battery 166 to an external power supply to provide power to the grooming appliance 100 during a grooming operation and/or to charge the battery 166. For example, the port 170 may be a universal serial bus (USB) type port or another standardized power port configured to receive one or more power cords for charging and/or for receiving power from an external power supply to operate the electric hair grooming appliance 100.

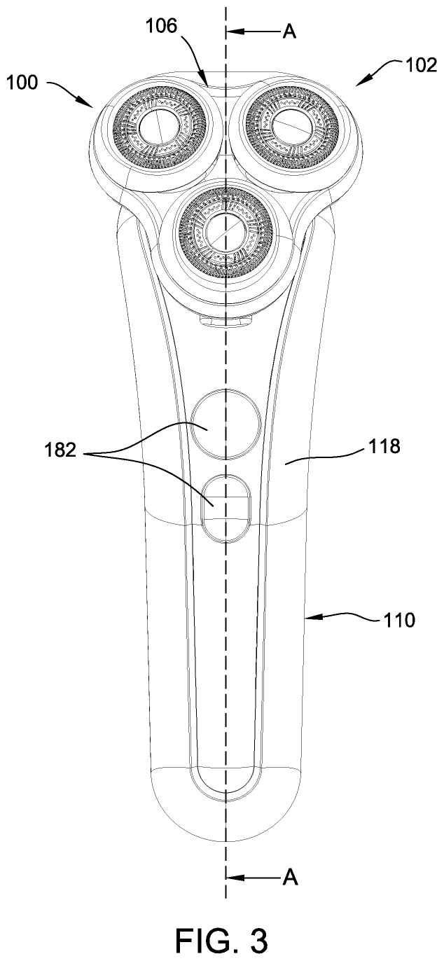

Referring to FIGS. 3 and 8, in the illustrated embodiment, the electric hair grooming appliance 100 includes a controller 172 and a user interface 174. In the illustrated embodiment, for example, the controller 172 is in the handle 110 but in other suitable embodiments the controller 172 can be in at least one of the head 102 and the pivot assembly 108. The controller 172 includes at least one processing device, which may include a single controller (e.g., microcontroller) or one or more controllers (e.g., microcontrollers), and a memory. The controller 172 may include or be connected to a transceiver that facilitates the controller 172 transmitting and receiving signals to and from the motor 132, the power supply 164, and the user interface 174. The electric hair grooming appliance 100 may also include one or more other electrical devices (e.g., input/output peripherals) in communication with the processing device and the memory. The memory stores a plurality of preprogrammed routines to be executed by the controller 172. The controller 172 is configured to transmit a signal to at least one of the user interface 174, the motor 132, and/or the power supply 164.

The power supply 164 is configured to supply power to the motor 132. In some embodiments, the power supply 164 may include a voltage regulator. In other suitable embodiments, the power supply 164 may be unregulated. In the illustrated embodiment, the power supply 164 is the battery 166 (shown in FIG. 8). Accordingly, the electric hair grooming appliance 100 is configured to function in a cordless mode and does not require an external power supply during operation. In some embodiments, the electric hair grooming appliance 100 includes a power cord and is configured to receive at least some power from an external power supply during operation.

In some embodiments, the controller 172 may transmit a signal to the power supply 164 to change a property of the power supply 164. For example, the controller 172 may transmit a signal to the power supply 164 to adjust the power output transferred from the power supply 164 to the motor 132.

The user interface 174 includes at least one user input device 180 configured to receive at least one input from a user. In this illustrated embodiment, the user input device 180 includes buttons 182. The buttons 182 are positioned through openings in the handle front 118 and are sized and shaped such that the buttons 182 may be easily be pressed by a user. In other suitable embodiments, the user interface 174 may include any additional user input devices 180 which may receive an input from a user. In some embodiments, user input devices 180 may include for example and without limitation, a screen, switches, microphones, speakers, dials, knobs, touchscreens, and/or toggles.

The input devices 180 may transmit information to the controller 172 based on an input received from the user. For example, in some embodiments, the user input devices 180 allows a user to select one or more modes, e.g., grooming mode, clean mode, and off mode. The user interface 174 sends a signal to controller 172 to switch the electric hair grooming appliance 100 to the selected mode. The user interface 174 may generate at least one of an auditory signal, a visual signal, or a tactile signal to be interpreted by a user. The auditory signal, the visual signal, and the tactile signals indicate to a user a parameter related to the electric hair grooming appliance 100. For example, the parameters may include, without limitation, battery life and the mode selected by a user. In other suitable embodiments, the parameters may include any parameters which indicate to a user a characteristic of the electric hair grooming appliance 100. The user interface 174 may include other output devices such as LEDs and/or a vibratory unit. For example, in some embodiments, the user interface 174 may include a speaker to generate an auditory signal to indicate to the user a parameter related to the electric hair grooming appliance 100.

In some embodiments, the controller 172 receives one or more user inputs and determines operating parameters of the electric hair grooming appliance 100 based at least partly on the user inputs. For example, the user may select a mode of operation or operational directive for the electric hair grooming appliance 100 such as operating to provide increased power or operating to increase battery efficiency. The controller 172 may increase or decrease the motor speed and/or change one or more other operating parameters based on the user directive.

Referring to FIGS. 3, 6, 8, and 9, the head 102 includes the cutting assembly, broadly a grooming device, 106 at the front 142. A cutting plane of the cutting assembly 106 is defined by the portions (e.g., blade assemblies 186) of the cutting assembly 106 that contact skin during a shaving operation. The cutting assembly 106 is positioned such that the handle 110 is spaced from the cutting assembly 106 a distance that allows a user to perform a grooming operation without significant impediment from the gripping hand of the user.

The cutting assembly 106 includes an outer frame 184 and at least one blade assembly 186. In this illustrated embodiment, the cutting assembly 106 includes three blade assemblies 186. The blade assemblies 186 each include a blade frame 188 and a blade unit 190. The blade frame 188 includes an opening 192. The opening 192 is circular and is sized and shaped to receive at least a portion of the blade unit 190. The blade frame 188 is configured to engage and support the blade unit 190 when the blade unit 190 is positioned within the opening 192.

In this illustrated embodiment, the outer frame 184 is a reuleaux triangle. The outer frame 184 is configured to support the blade frames 188. For example, one of the outer frame 184 or the blade frames 188 may include at least one pin formed thereon and the other of the outer frame 184 or the blade frames 188 may include at least one opening sized and shaped to receive at least a portion of the pin. Each blade frame 188 is rotatable relative to the outer frame 184. As a result, the blade assembly 186 may flex and pivot relative to the outer frame 184 such that the blade assembly 186 may deflect in response to forces applied to the blade assemblies 186 during a grooming operation.

Each blade unit 190 includes a first blade 194, a second blade 196, and a blade coupling unit 198. The first blade 194 includes a circular endwall 191 and a sidewall 193 extending circumferentially around an edge of the circular endwall 191. The circular endwall 191 and the sidewall 193 define a cavity 195. The second blade 196 and at least a portion of the blade coupling unit 198 are received within the cavity of the first blade 194. The first blade 194 includes a plurality of perforations 200 formed thereon. The perforations 200 are sized and shaped such that hair may pass through the first blade 194 and extend between the second blade 196 and the first blade 194. Hair disposed between the first blade 194 and the second blade 196 is cut as the second blade 196 rotates relative to the first blade 194. The blade assemblies 186 are arranged in an equilateral triangular pattern relative to the outer frame 184. The blade frames 188 are arranged such that there is sufficient clearance between adjacent blade assemblies 186 to allow each blade assembly 186 to flex with limited interference from an adjacent blade assembly 186. In other suitable embodiments, the blade assemblies 186 may be arranged in any configuration which enables the cutting assembly 106 to perform as described herein. In some embodiments, the electric hair grooming appliance 100 may include one blade assembly 186 or a plurality of blade assemblies 186 arranged in any suitable manner.

The blade coupling unit 198 includes a mount 202 formed thereon. Each of the second blades 196 includes a central aperture 204. The central aperture 204 is sized and shaped to receive at least a portion of the mount 202 for coupling each of the second blades 196 to the blade coupling unit 198. The blade coupling unit 198 engages the second blades 196 such that rotation of the blade coupling unit 198 causes rotation of the second blade 196.

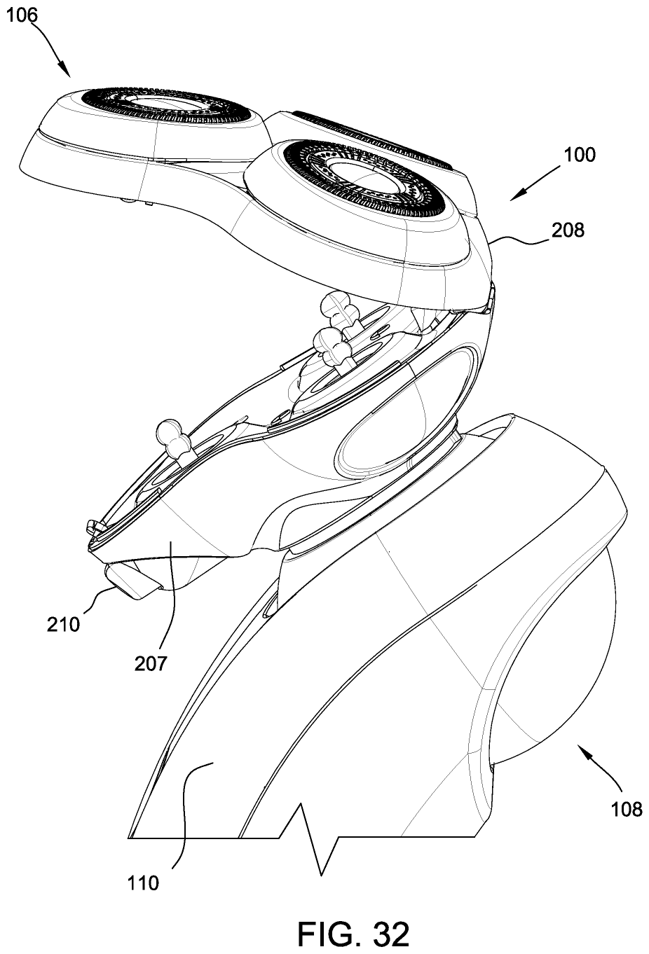

In this illustrated embodiment, the head 102 defines a hair pocket 206 underneath the cutting assembly 106. The hair pocket 206 is configured to capture and store hair that is cut during a grooming session. The cutting assembly 106 is selectively positionable between a closed position (shown in FIG. 5) and an opened position (shown in FIG. 32) to allow a user to open the head 102 and expose the hair pocket 206 for cleaning. For example, the head 102 includes a button 210 that is pressed by a user to release the cutting assembly 106 and facilitate the cutting assembly 106 moving to the opened position. In this illustrated embodiment, the cutting assembly 106 is attached to a housing 207 of the head 102 by a hinge 208 such that the cutting assembly 106 is attached to the housing 207 when the cutting assembly 106 is in the opened position. In other embodiments, the cutting assembly 106 is detached from the housing 207 when the cutting assembly 106 is in the opened position.

Referring again to FIG. 9, in this illustrated embodiment, the drive assembly 152 further includes a blade drive shaft 212 for each blade assembly 186. Each of the blade drive shafts 212 includes a stem 214, a base 216, and a bit 218. The bit 218 is substantially cubic in shape. The blade drive shaft 212 further includes at least one tab 220 that extends outward from the base 216. Each of the blade drive shafts 212 extends from the back 140 toward the cutting assembly 106. The drive assembly 152 includes the drive train 158 that transfers rotation of the motor 132 into driving movement of each of the blade drive shafts 212 which are rotationally coupled to the cutting assembly 106 during operation of the electric hair grooming appliance 100.

The blade coupling unit 198 has an opening 222 defined thereon. The opening 222 is substantially cuboidal in shape. The opening 222 is sized and shaped to receive at least a portion of the bit 218. The bit 218 is at least partially engaged with the blade coupling unit 198 such that each of the blade drive shafts 212 is rotationally coupled with one of the blade coupling units 198. Rotation of the blade drive shaft 212 causes rotation of the blade coupling unit 198 which further causes rotation of at least one of the second blades 196. The blade coupling unit 198 may flex and extend relative to the blade drive shaft 212.

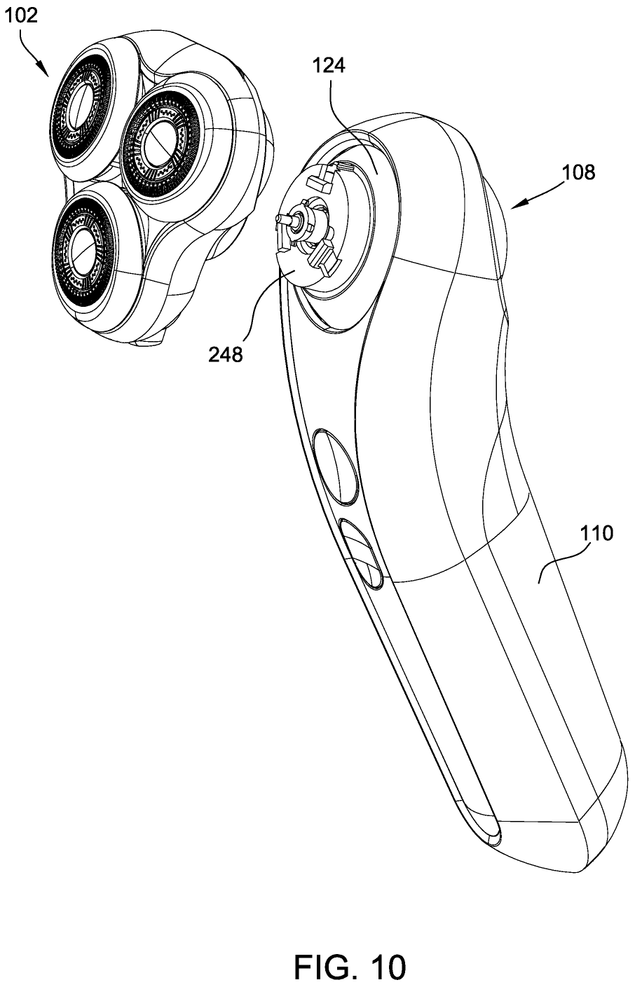

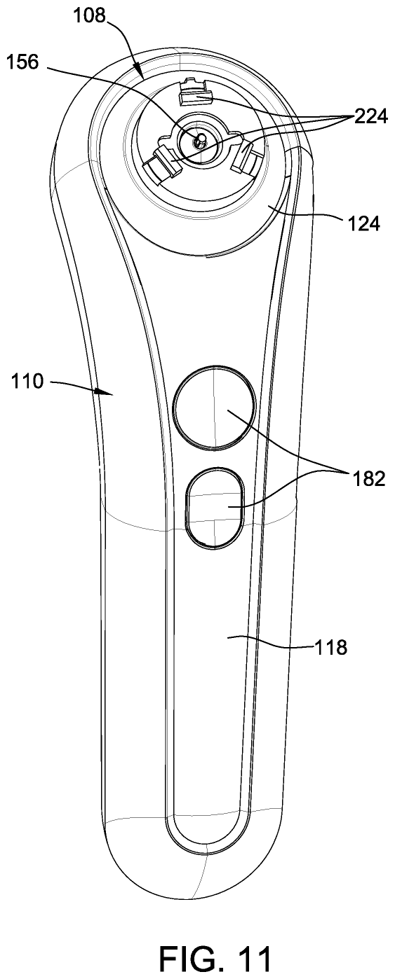

As shown in FIGS. 9-12, the head 102 is detachably mounted to the pivot assembly 108. For example, the pivot assembly 108 includes first clips 224 and the back 140 of the head 102 includes second clips 226 that engage the first clips 224. In this illustrated embodiment, the electric hair grooming appliance 100 includes three sets of first and second clips 224, 226. The clips 224, 226 are evenly spaced around the motor drive shaft 154. Each of the clips 224, 226 includes a stem 228 and a hook 230 attached to an end of the stem 228. The stems 228 flex and the hooks 230 move past each other for corresponding clips 224, 226 to engage/disengage when a threshold force is applied to the head 102 and/or the pivot assembly 108. In other suitable embodiments, the head 102 and/or the pivot assembly 108 include other engagement features without departing from some aspects of the disclosure. For example, in some embodiments, the head 102 or the pivot assembly 108 includes one or more notches or openings that are configured to receive corresponding clips 224, 226. In further embodiments, the head 102 is not detachable from the pivot assembly 108.

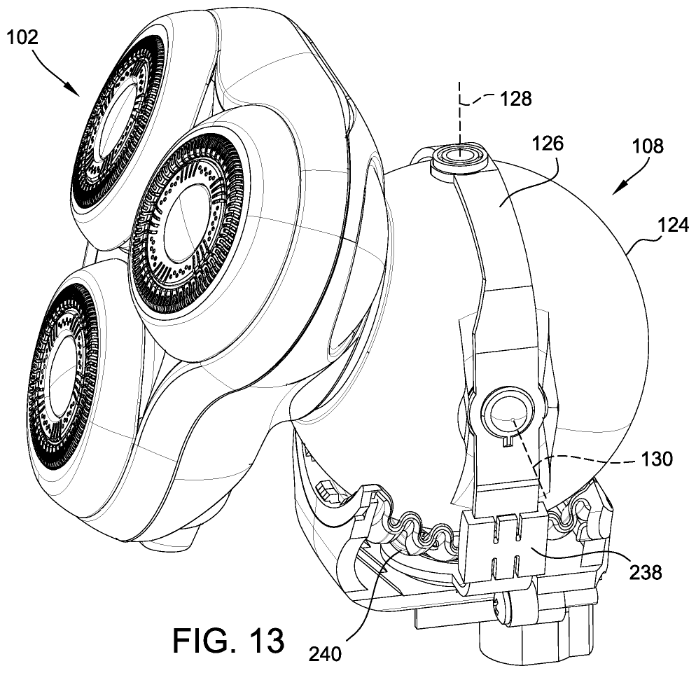

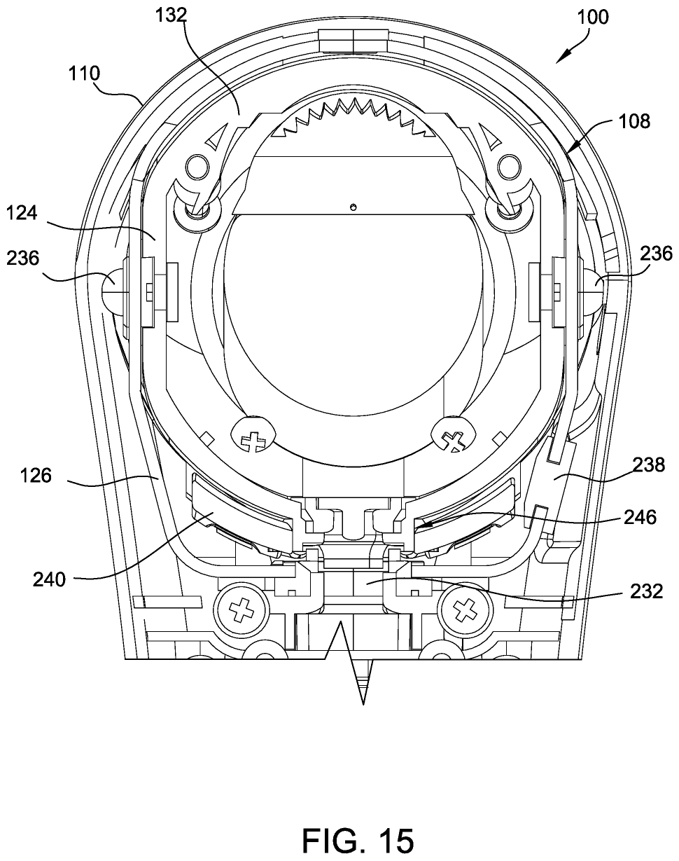

Referring to FIGS. 13-15, the pivot assembly 108 includes the spherical housing 124, the strap 126, and at least one bearing 232, 234. At least a portion of the pivot assembly 108 is configured to move about each of the pivot axes 128, 130. For example, the strap 126 and the spherical housing 124 are configured to pivot relative to the handle 110 about the first pivot axis 128. The spherical housing 124 is configured to pivot relative to the strap 126 and the handle 110 about the second pivot axis 130.

The strap 126 extends at least partly around a circumference of the spherical housing 124 and pivotably supports the spherical housing 124. In the illustrated embodiment, the strap 126 extends around the entire circumference of the spherical housing 124. In addition, the pivot assembly 108 includes a clasp 238 that secures the strap 126 around the spherical housing 124. The clasp 238 is positionable between an opened position that facilitates positioning the strap 126 around the spherical housing 124 and a closed position that secures the strap 126 around the spherical housing 124. The strap 126 has a gap and is configured to receive the spherical housing 124 when the clasp 238 is in the opened position. The strap 126 forms a continuous loop and is sized to fit around the spherical housing 124 when the clasp 238 is in the closed position. In other embodiments, the clasp 238 is omitted and the strap 126 includes a single piece that extends continuously around the entire circumference of the spherical housing 124.

The bearings 232, 234 are attached to the strap 126 and the handle 110 and facilitate movement of the strap 126 and the spherical housing 124 relative to the handle 110. In the illustrated embodiment, the pivot assembly 108 includes a lower bearing 232 and an upper bearing 234. The lower bearing 232 and the upper bearing 234 are positioned on opposite sides of the strap 126. The lower bearing 232 and the upper bearing 234 facilitate the pivot assembly 108 rotating about the first pivot axis 128. In this illustrated embodiment, the first pivot axis 128 extends through the centers of the lower bearing 232, the upper bearing 234, and the spherical housing 124. The first pivot axis 128 is oblique to the handle axis 112. In some embodiments, the bearings 232, 234 include ball bearings, roller bearings, fluid bearings, magnetic bearings, and/or any other suitable bearing.

The pivot assembly 108 includes two pins 236 that attach to the spherical housing 124 and the strap 126 on opposite sides of the strap 126. The pins 236 facilitate the spherical housing 124 rotating relative to the strap 126 about the second pivot axis 130. The second pivot axis 130 extends through the pins 236 and the center of the spherical housing 124 and is perpendicular to the first pivot axis 128. The second pivot axis 130 is perpendicular to the handle axis 112.

As shown in FIGS. 13-15, the electric hair grooming appliance 100 includes a bias member 240 extending between the pivot assembly 108 and the handle 110. The bias member 240 is an elastic sheet and is configured to provide a bias force to the spherical housing 124 of the pivot assembly 108 in at least two directions. Specifically, the bias member 240 is configured to provide a bias force to the spherical housing 124 relative to the first and second pivot axes 128, 130. For example, the bias member 240 contacts the pivot assembly 108 when the spherical housing 124 pivots about the first and/or second pivot axes 128, 130 and applies a bias force to the pivot assembly 108 to bias the pivot assembly 108 toward a neutral position.

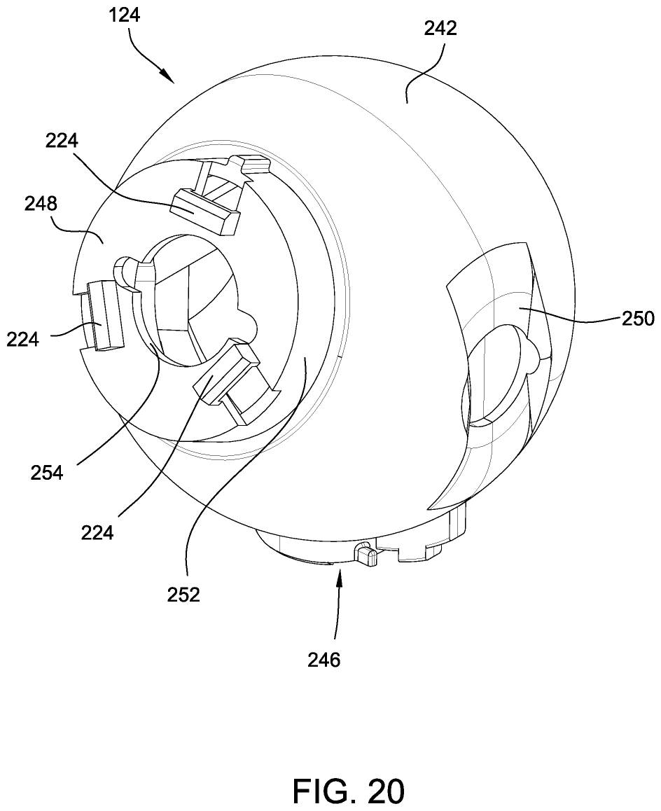

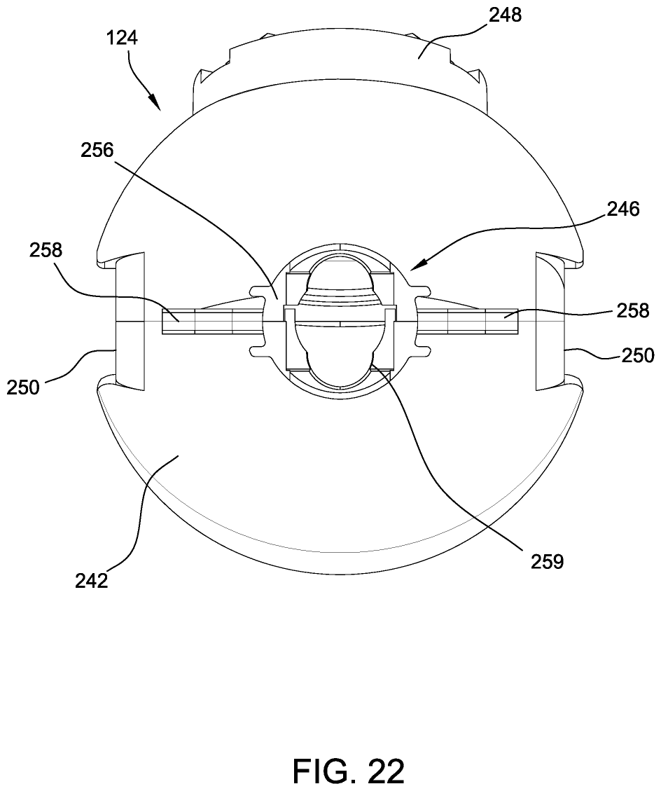

Referring to FIGS. 9 and 20-22, the spherical housing 124 includes an outer surface 242, at least one engagement feature 246, and a head engagement block 248. The outer surface 242 of the spherical housing 124 is curved and has a diameter 244. The outer surface 242 defines two grooves 250. Each pin 236 is attached to the spherical housing 124 within one of the grooves 250. The grooves 250 are sized to receive the strap 126 and accommodate rotation of the spherical housing 124 relative to the strap 126. For example, a width of the grooves 250 is greater than a width of the strap 126 to provide clearance for the strap 126 within the grooves 250 when the spherical housing 124 pivots relative to the strap 126. In this illustrated embodiment, the spherical housing 124 is attached to the head 102 and the handle 110 such that curved portions of the spherical housing 124 are visible to the user. For example, the handle 110 forms a collar that extends around the spherical housing 124 and encloses and conceals the strap 126 and other components of the pivot assembly 108. The handle back 120 includes an opening through which the outer surface 242 is visible. As result, the spherical housing 124 provides the appearance of ball within a socket which may be visually attractive to the user.

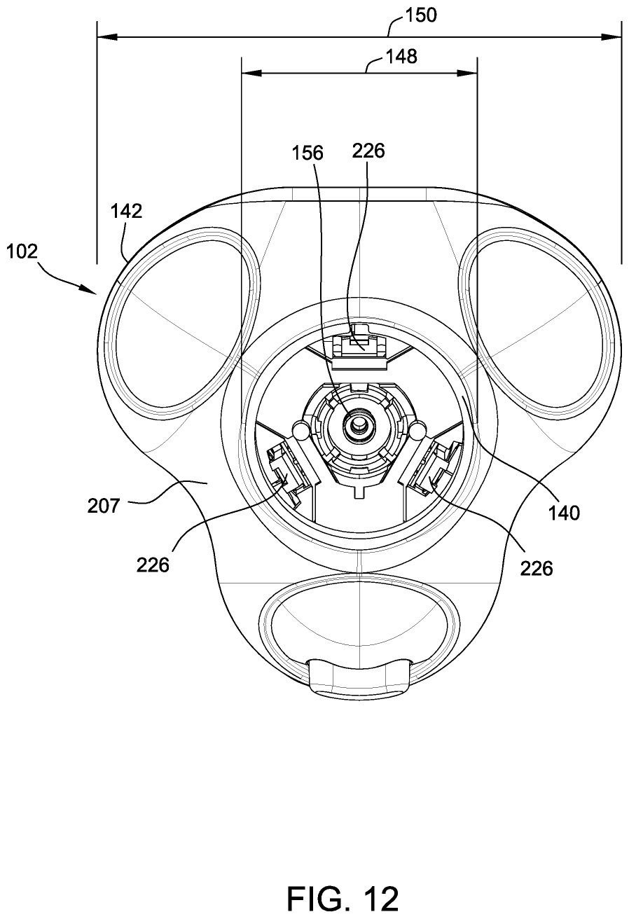

The head engagement block 248 includes the clips 226 and a base 252. The base 252 has a shape that matches the shape of the back 140 of the head 102 (shown in FIG. 12). Specifically, in this illustrated embodiment, the head engagement block 248 is cylindrical and extends outward from the outer surface 242. The clips 226 extend outward from the base 252 and are spaced around the central opening 254 on the base 252. In addition, the base 252 defines a central opening 254 sized to receive the motor drive shaft 154. The head engagement block 248 is configured to facilitate simple attachment/detachment of the pivot assembly 108 and the head 102.

The head engagement block 248 and the motor drive shaft 154 which extends through the head engagement block 248 are arranged at an oblique angle relative to the handle axis 112 of the handle 110 when the head 102 is in a neutral or nondisplaced position. In addition, the cutting plane of the head 102 is perpendicular to the motor drive shaft 154 and oblique to the handle axis 112 of the handle 110. As a result, the grooming appliance 100 is configured for the user to grasp the handle 110 in a more comfortable or natural position as the head 102 follows the contours of the skin.

The spherical housing 124 of the pivot assembly 108 includes engagement features 246 projecting outward from the outer surface 242 of the spherical housing 124. For example, the engagement features 246 of the spherical housing 124 include a post 256 and ribs 258. The bias member 240 is configured to engage the engagement features 246 extending from the spherical housing 124. In other embodiments, the spherical housing 124 and/or the bias member 240 include other engagement features without departing from some aspects of the disclosure.

In some embodiments, the spherical housing 124 defines one or more openings 259 configured to receive components extending from the handle 110. In this illustrated embodiment, the post 256 defines the opening 259. The opening 259 is sized and arranged to receive one or more conduits or wires for connecting the power supply 164 within the handle 110 to the motor 132 within the spherical housing 124.

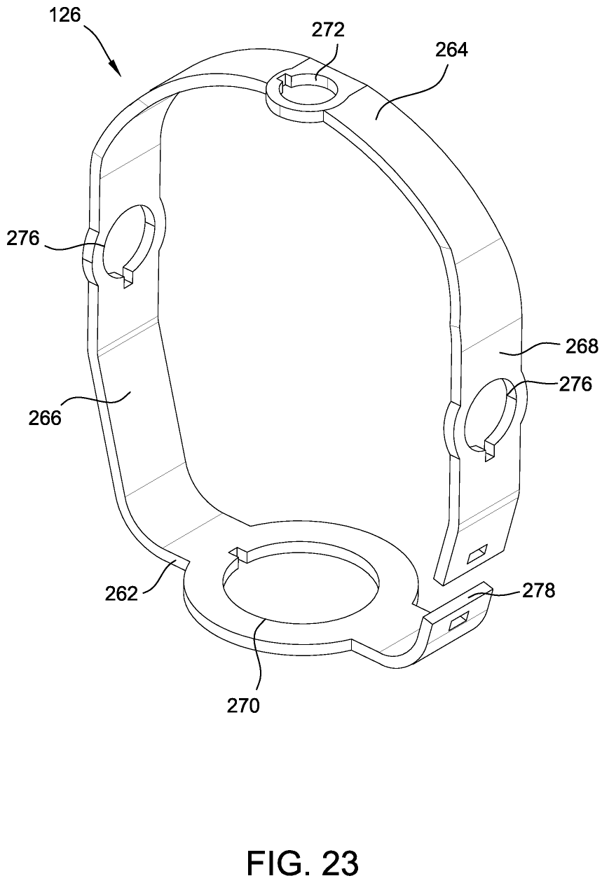

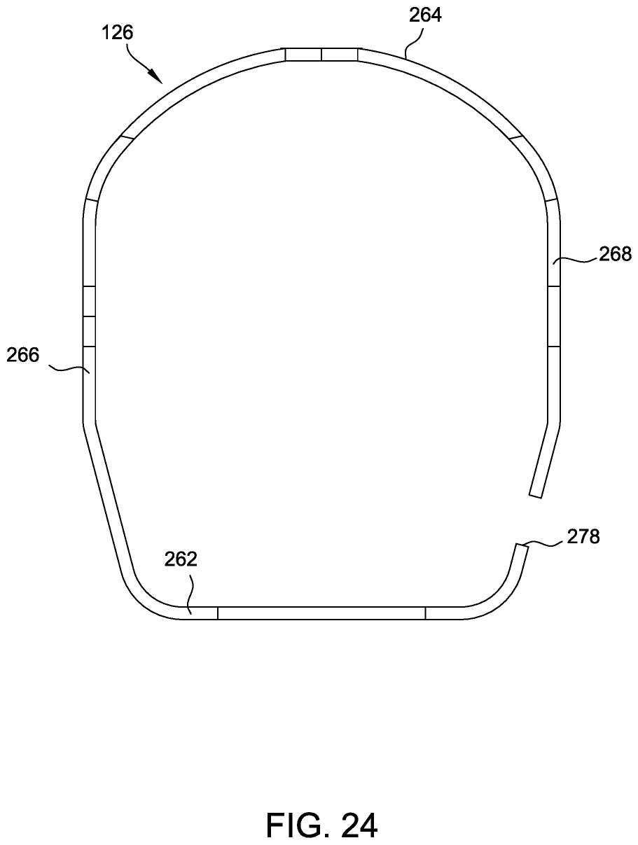

With reference to FIGS. 23 and 24, the strap 126 is a single rigid piece that is shaped and sized to extend around the spherical housing 124. In the illustrated embodiment, the strap 126 is metal. The strap 126 includes a bottom 262, a top 264, a first side 266, and a second side 268. The top 264 and the bottom 262 are configured for mounting the strap 126 within the handle 110 via the bearings 232, 234. For example, the bottom 262 defines an opening 270 sized to receive the lower bearing 232. The top 264 defines an opening 272 sized to receive the upper bearing 234.

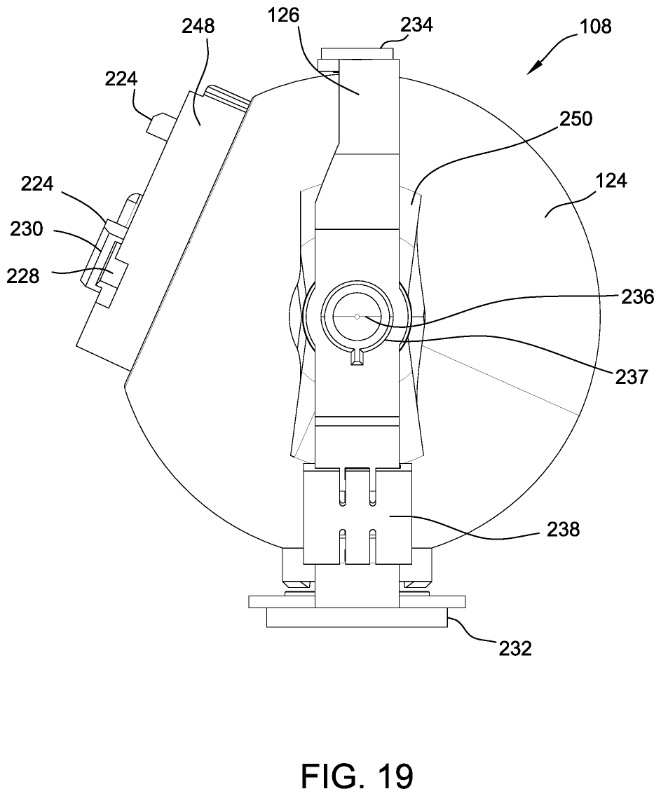

The first side 266 and the second side 268 of the strap 126 define openings 276 sized to receive the pins 236 for supporting the spherical housing 124. In the illustrated embodiment, bearings 237 are positioned on the pins 236 to facilitate movement of the pins 236. The pins 236 and the bearings 237 are positioned in the openings 276 in the strap 126. The second side 268 has a gap 278 and is configured to receive the clasp 238 (shown in FIG. 19). The clasp 238 is configured to secure the strap 126 about the spherical housing 124. The gap 278 facilitates the strap 126 being positioned about the spherical housing 124. The strap 126 is configured to extend about the entire circumference of the spherical housing 124 when the strap 126 is closed by the clasp 238. As a result, the strap 126 supports the spherical housing 124 and provides a robust feel during movement of the pivot assembly 108. The pivot assembly 108 may include other straps 126 without departing from some aspects of the disclosure.

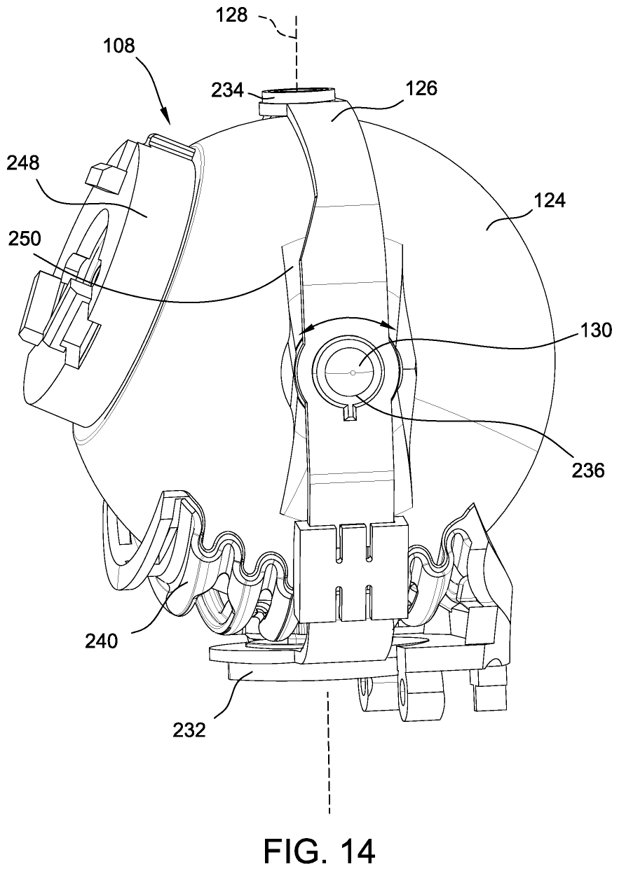

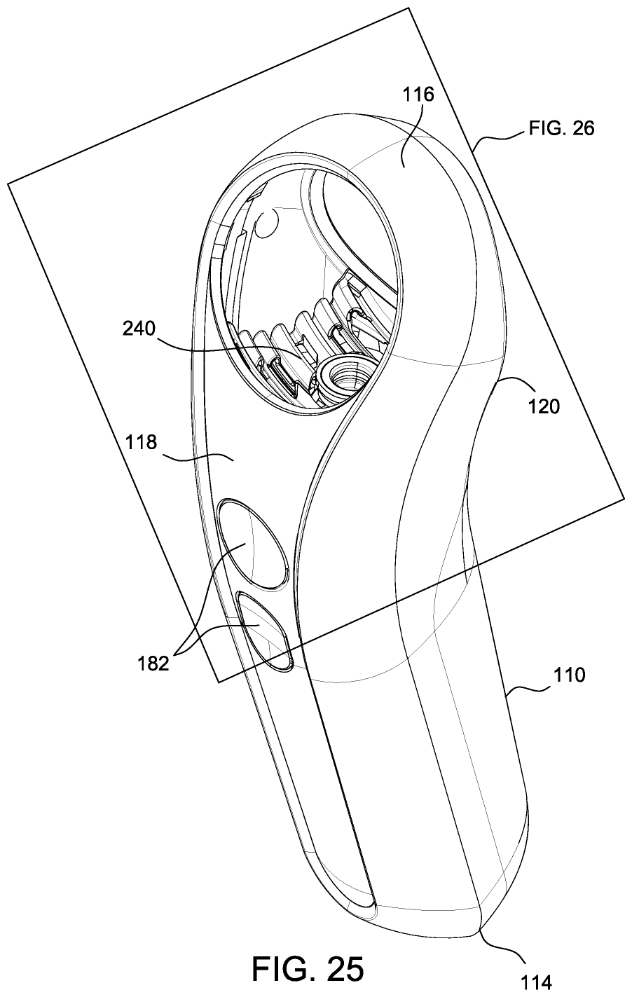

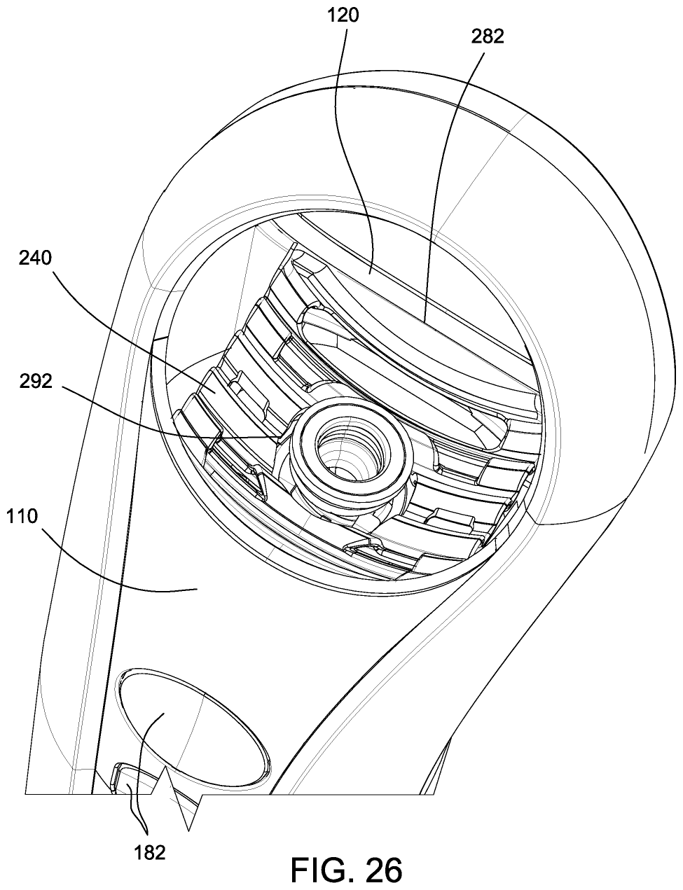

As shown in FIGS. 25-27, the bias member 240 is mounted at least partly within the handle 110 and is arranged to bias the pivot assembly 108 (shown in FIG. 14) toward a neutral or nondisplaced position. The bias member 240 includes a front edge 280, a back edge 282, and side edges 284 extending between the front and back edges 280, 282. The front edge 280 is parallel to the back edge 282. The side edges 284 are perpendicular to the front and back edges 280, 282. The front and back edges 280, 282 include flanges 286 configured to engage the handle front 118 and the handle back 120.

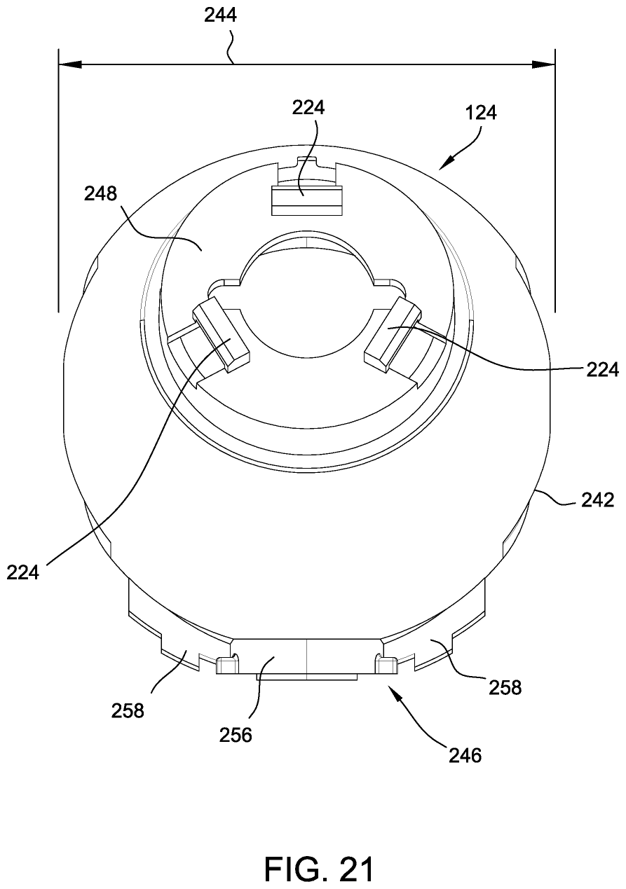

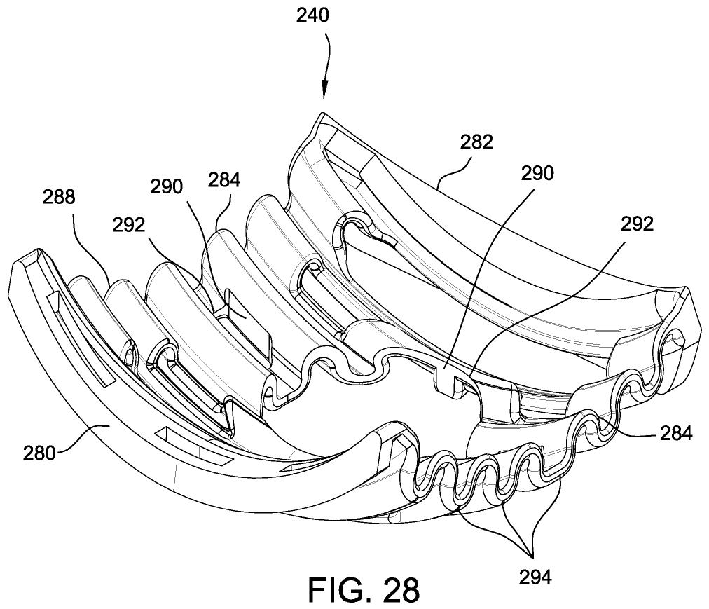

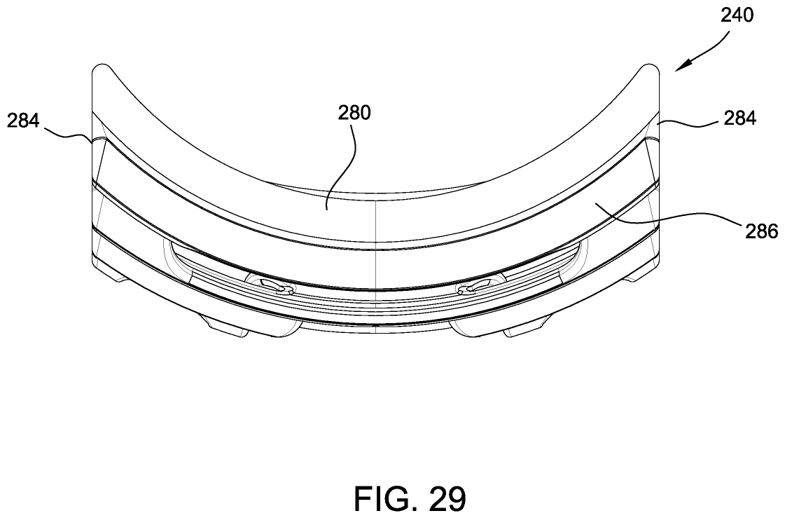

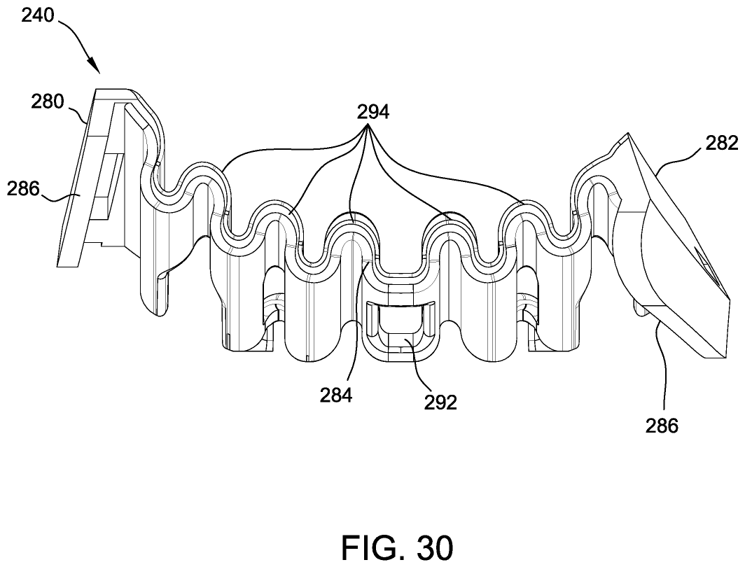

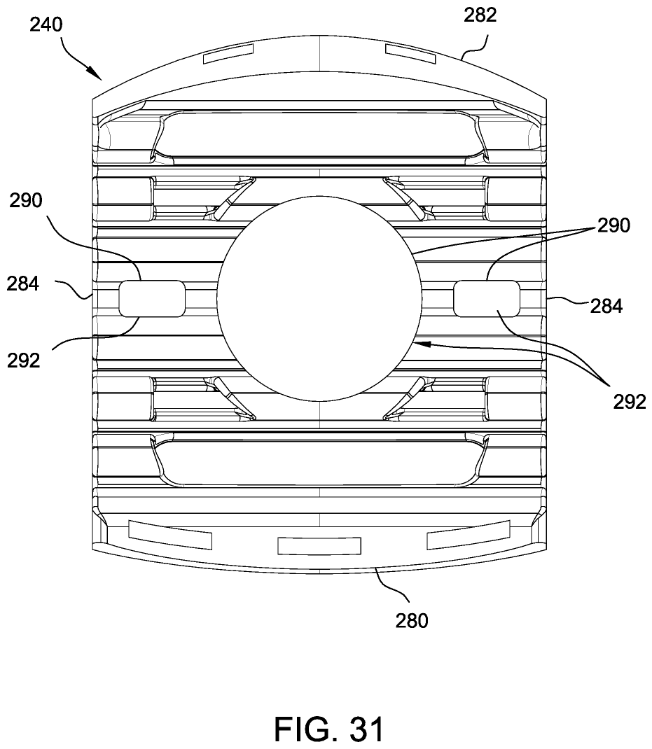

With reference to FIGS. 28-31, the front edge 280, the back edge 282, and the side edges 284 form an outer edge 288 of the bias member 240. The bias member 240 includes at least one inner edge 290 defining at least one engagement opening 292 spaced from the outer edge 288. In the example embodiment, the inner edge 290 defines three of the engagement openings 292. The engagement openings 292 are sized and shaped to receive engagement features 246 of the pivot assembly 108. For example, the middle engagement opening 292 is a circle and is sized to receive the post 256 of the spherical housing 124 (shown in FIG. 21). The outer engagement openings 292 are rectangles and are sized to receive the ribs 258 of the spherical housing 124 (shown in FIG. 21).

In addition, in this illustrated embodiment, the bias member 240 includes a plurality of corrugations 294 extending from the first side edge 284 to the second side edge 284. The corrugations 294 are evenly spaced between and extend parallel to the outer edge 288 and the inner edge 290. The corrugations 294 facilitate the bias member 240 flexing when the pivot assembly 108 is displaced and providing a bias force to bias the pivot assembly 108 toward the neutral position.

The front edge 280 of the bias member 240 is fixed relative to the handle front 118. The back edge 282 of the bias member 240 is fixed relative to the handle back 120. For example, the flange 286 on the front edge 280 engages the handle front 118 and the flange 286 on the back edge 282 engages the handle back 120. If the pivot assembly 108 is displaced, the pivot assembly 108 contacts the inner edges 290 of the bias member 240 and compresses the bias member 240 between the pivot assembly 108 and the handle front 118 or the handle back 120. The bias member 240 is elastic and provides a bias force to the pivot assembly 108 to bias the pivot assembly 108 toward the neutral position when the bias member 240 is compressed.

The bias member 240 is non-planar. For example, the bias member 240 is curved to correspond to the radius of the spherical housing 124. As a result, the bias member 240 extends along the spherical housing 124 and facilitates the pivot assembly 108 having a compact shape. Also, the bias member 240 provides a consistent bias force to the spherical housing 124 when the spherical housing 124 is displaced in any direction. The bias member 240 may be other shapes without departing from some aspects of the disclosure. For example, in some embodiments, the bias member 240 is planar.

The bias member 240 is any suitable material. For example, in some embodiments, the bias member 240 is constructed of an elastomeric material such as rubber. The bias member 240 facilitates the cutting assembly 106 having a selected range of motion about the pivot axes 128, 130. As seen in FIG. 14, in the illustrated embodiment, for example, the cutting assembly 106 is arranged to pivot up to 45° about the first pivot axis 128 and up to 45° about the second pivot axis 130.

With reference to FIGS. 8 and 14, during operation, the handle 110 of the electric hair grooming appliance 100 is grasped by a user. The user positions the head 102 proximate the skin of the user to perform a grooming operation. The user presses one of the buttons 182 to activate the electric hair grooming appliance 100 and the controller 172 transmits a signal to cause the power supply 164 to supply power to the motor 132. The motor 132 drives the cutting assembly 106 to cut hair as the head 102 is moved along the skin. The pivot assembly 108 facilitates the head 102 following the contours of the skin for the cutting assembly 106 to provide a consistent grooming experience. For example, the pivot assembly 108 facilitates the head 102 moving smoothly about the first pivot axis 128 and/or the second pivot axis 130 relative to the handle during the grooming operation. The bias member 240 provides a bias force to the pivot assembly 108 to bias the head 102 towards the operating position and facilitates the cutting assembly 106 remaining in close contact with the skin as the head 102 moves to follow the contours of the skin. The user may press one of the buttons to power off the electric hair grooming appliance when the grooming operation is complete. After the grooming operation, the user may open the head 102 by pressing the button 210 to move the cutting assembly 106 to the opened position and expose the hair pocket 206 for cleaning.

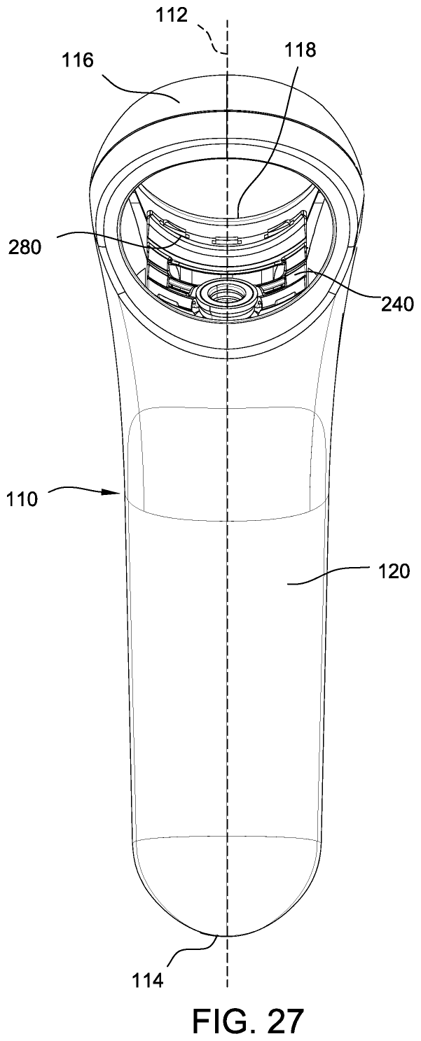

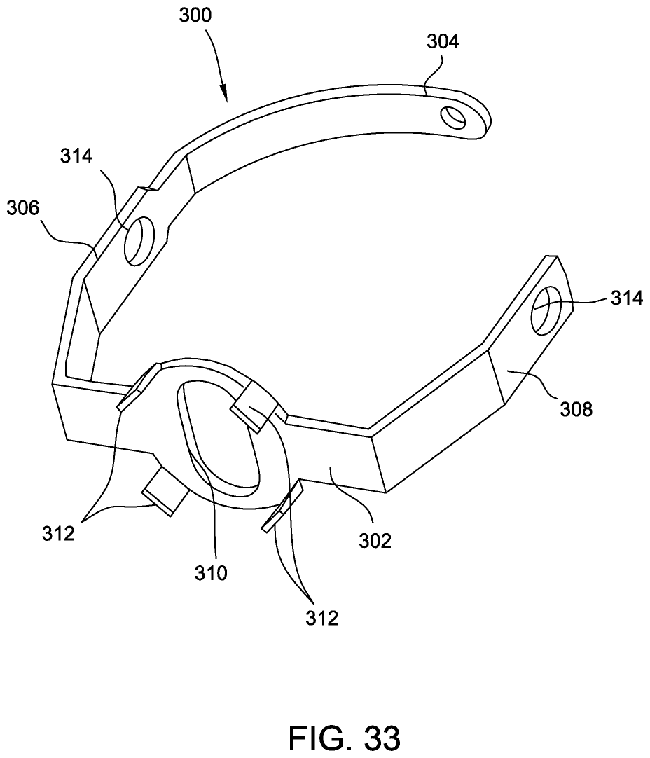

FIG. 33 is a perspective view of another suitable embodiment of a strap 300 suitable for use with the electric hair grooming appliance 100 (shown in FIGS. 1-7). The strap 300 is configured to extend partly around the circumference of the spherical housing 124 (shown in FIG. 27) of the electric hair grooming appliance 100.

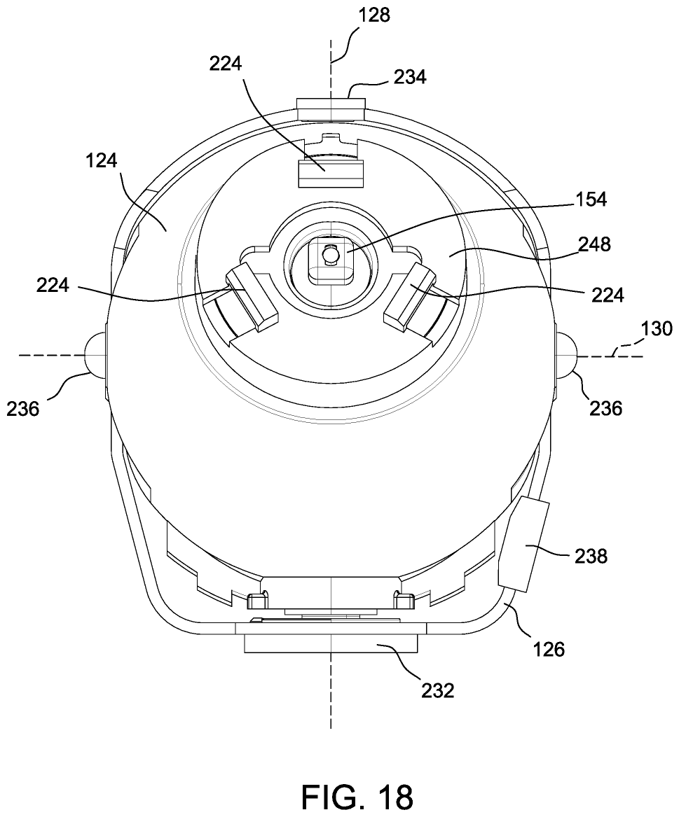

The strap 300 is a single rigid piece that is shaped and sized to extend partly around the spherical housing 124. In the illustrated embodiment, the strap 300 is metal. The strap 300 includes a bottom 302, a top 304, a first side 306, and a second side 308. The bottom 302 is configured for mounting the strap 126 to the handle 110. For example, the bottom 302 defines an opening 310 and tabs 312 that are configured to engage the bearing 232 (shown in FIG. 25) and/or the handle 110 of the grooming appliance (shown in FIG. 1). The first side 306 and the second side 308 of the strap 300 define openings 314 sized to receive the pins 236 (shown in FIG. 25) and are configured to support the spherical housing 124 (shown in FIG. 18).

The top 304 and the second side 308 of the strap 300 each have a length that is less than the diameter of the spherical housing 124 and the top 304 and the second side 308 are not connected together. Accordingly, the strap 300 does not extend continuously around the entire circumference of the spherical housing 124. As a result, the strap 300 may be simpler to position around the spherical housing 124 than straps which extend around the entire circumference of the spherical housing 124.

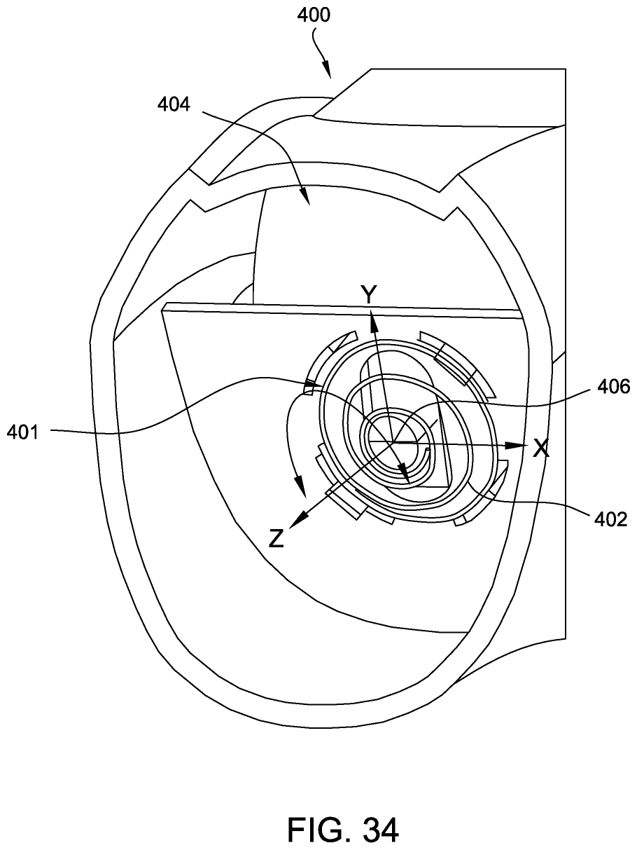

FIG. 34 is a perspective view of a portion of another exemplary embodiment of an electric hair grooming appliance 400. The electric hair grooming appliance 400 is similar to the electric hair grooming appliance 100 except the electric hair grooming appliance 400 includes a bias member 401 including a helical spring 402 that biases a pivot assembly 404 of the electric hair grooming appliance 400 toward a neutral or nondisplaced position. The helical spring 402 extends around and engages an engagement feature 406 of the pivot assembly 404. The helical spring 402 provides a bias force to the engagement feature 406 in at least two directions. For example, the helical spring 402 provides bias forces in an X-direction, a Y-direction, and a torsional direction about the Z-axis. The helical spring 402 may be constructed of metal.

Embodiments described above include grooming appliances that include a pivot assembly, a grooming device, and a handle. The pivot assembly facilitates the grooming device pivoting relative to a body of the grooming appliance and facilitates the head following contours of skin during a grooming operation. The pivot assembly includes a spherical housing and a strap supporting the physical housing. The pivot assembly may provide a greater range of motion for the grooming device relative to the handle in comparison to other grooming appliances. For example, the grooming device may pivot about at least two axes extending through the pivot assembly. In addition, the pivot assembly is robust and resists damage during operation. Also, the pivot assembly and the grooming appliance may be aesthetically appealing to users.

In some embodiments, the grooming appliance includes a motor that is housed within the pivot assembly. As a result, the grooming appliance may be balanced and provide a more comfortable feel for a user during operation. In addition, the grooming appliance may be simpler to assemble and maintain because the grooming appliance does not require a drive system to extend across a pivot interface of the grooming device and the handle. In addition, the drive motor is oriented along the head axis and not the handle axis.

Also, in further embodiments, the grooming device of the grooming appliance is detachable from the handle of the grooming appliance. For example, the grooming device may be detached from the pivot assembly attached to the handle.

In some embodiments, the grooming appliance includes a bias member that is configured to provide a bias force to at least one of the head and the pivot assembly to bias the head toward a neutral position. For example, the bias member may include an elastic sheet that is configured to provide a bias force about each pivot axis of the head. In some embodiments, the bias member is shaped to match a shape of the pivot assembly. Also, the bias member may be corrugated. As a result, the grooming appliance with the bias member is simpler to manufacture and more durable than other grooming appliances.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An electric hair grooming appliance comprising:
a handle;
a hair grooming device;
a pivot assembly pivotably attaching the hair grooming device to the handle, the pivot assembly includes a housing, wherein the hair grooming device and the housing are pivotable relative to the handle about at least two pivot axes extending through the housing; and
a motor contained in the housing, wherein the motor is configured to drive the hair grooming device.

2. An electric hair grooming appliance in accordance with claim 1, wherein the hair grooming device comprises a hair cutting device including at least one blade configured to cut hair.

3. An electric hair grooming appliance in accordance with claim 1, wherein the housing has a circumference, and wherein the pivot assembly further comprises a strap extending at least partly around the circumference of the housing and pivotably supporting the housing to the handle.

4. An electric hair grooming appliance in accordance with claim 3, wherein the strap extends around the entire circumference of the housing.

5. An electric hair grooming appliance in accordance with claim 3, wherein the pivot assembly includes two pins that attach the strap to the housing.

6. An electric hair grooming appliance in accordance with claim 3, wherein the strap is metal.

7. An electric hair grooming appliance in accordance with claim 3, wherein the pivot assembly includes a bearing disposed between the strap and the handle to facilitate movement of the strap and the housing relative to the handle.

8. An electric hair grooming appliance in accordance with claim 1, wherein the handle extends along a longitudinal axis, and wherein the at least two pivot axes are not parallel to the longitudinal axis.

9. An electric hair grooming appliance in accordance with claim 8, wherein one of the at least two pivot axes is oblique to the longitudinal axis of the handle.

10. An electric hair grooming appliance in accordance with claim 8, wherein the motor includes a drive shaft extending through the housing to attach to the hair grooming device, and wherein the drive shaft is not parallel to the longitudinal axis of the handle.

11. An electric hair grooming appliance comprising:
a handle;
a hair grooming device;
a pivot assembly pivotably attaching the hair grooming device to the handle and including a housing, wherein the hair grooming device and the housing are pivotable relative to the handle about at least two pivot axes extending through the housing; and
a bias member disposed between the pivot assembly and the handle, wherein the bias member includes an outer edge configured to engage the handle and an inner edge configured to engage the pivot assembly, wherein the bias member is configured to bias the housing against movement about the at least two pivot axes.

12. An electric hair grooming appliance in accordance with claim 11, wherein the bias member comprises an elastic sheet.

13. An electric hair grooming appliance in accordance with claim 12, wherein the housing is spherical, and wherein the elastic sheet is curved to correspond to a radius of the housing.

14. An electric hair grooming appliance in accordance with claim 12, wherein the elastic sheet is corrugated.

15. An electric hair grooming appliance in accordance with claim 11, wherein the pivot assembly includes an engagement feature extending from the housing, wherein the inner edge of the bias member defines at least one opening configured to receive the engagement feature.

16. An electric hair grooming appliance in accordance with claim 15, wherein the handle includes a front and a back, wherein the outer edge of the bias member is configured to engage the front and the back of the handle, and wherein the opening is spaced from the outer edge.

17. An electric hair grooming appliance comprising:
a handle;
a hair grooming device; and
a pivot assembly pivotably attaching the hair grooming device to the handle, the pivot assembly includes a housing and a strap, the housing has a circumference, the strap extends at least partly around the circumference of the housing and pivotably supports the housing, wherein the hair grooming device and the housing are pivotable relative to the handle about at least two pivot axes extending through the housing.

18. An electric hair grooming appliance in accordance with claim 17, wherein the hair grooming device comprises a hair cutting device including at least one blade configured to cut hair.

19. An electric hair grooming appliance in accordance with claim 17, wherein the strap extends around the entire circumference of the housing.

20. An electric hair grooming appliance in accordance with claim 17, wherein the pivot assembly includes two pins that attach the strap to the housing.

21. An electric hair grooming appliance in accordance with claim 17, wherein the strap is metal.

22. An electric hair grooming appliance in accordance with claim 17, wherein the pivot assembly includes a bearing disposed between the strap and the handle to facilitate movement of the strap and the housing relative to the handle.

23. An electric hair grooming appliance in accordance with claim 17, wherein the handle extends along a longitudinal axis, and wherein the at least two pivot axes are not parallel to the longitudinal axis.

24. An electric hair grooming appliance in accordance with claim 23, wherein one of the at least two pivot axes is oblique to the longitudinal axis of the handle.
